(19) United States
(12) Patent Application Publication
(10) Pub. No.: US 2025/0202591 A1
(43) Pub. Date: Jun. 19, 2025

(54) OPTICAL COMMUNICATION SYSTEM AND OPTICAL COMMUNICATION METHOD

(71) Applicant: NEC Corporation, Tokyo (JP)

(72) Inventor: Yurie MATSUYAMA, Tokyo (JP)

(73) Assignee: NEC Corporation, Tokyo (JP)

(21) Appl. No.: 18/971,168

(22) Filed: Dec. 6, 2024

(30) Foreign Application Priority Data
Dec. 18, 2023 (JP) 2023-212856

(51) Int. Cl. H04B 10/564; H04B 10/60

(52) U.S. Cl. CPC H04B 10/564; H04B 10/60

(57) ABSTRACT

An aim is to provide an optical communication system and an optical communication method for transmitting a wavelength-multiplexed signal whose signal quality on a reception side is adjusted to desired quality. A first optical transmitter outputs a first optical signal of a first wavelength at a first transmission intensity. A second optical transmitter outputs a second optical signal of a second wavelength longer than the first wavelength at a second transmission intensity lower than the first transmission intensity. A multiplexer outputs a third optical signal obtained by multiplexing the first optical signal and the second optical signal to an optical transmission line. The intensity of the first optical signal transmitted through the optical transmission line is reduced by inter-signal stimulated Raman scattering. The second optical signal transmitted through the optical transmission line is amplified by the inter-signal stimulated Raman scattering of the first optical signal.

### INCORPORATION BY REFERENCE

This application is based upon and claims the benefit of priority from Japanese patent application No. 2023-212856, filed on Dec. 18, 2023, the disclosure of which is incorporated herein in its entirety by reference.

### TECHNICAL FIELD

The present disclosure relates to optical communication systems and methods.

### BACKGROUND ART

In the field of optical communication, wavelength division multiplexing (WDM), in which a plurality of optical signals having different wavelengths are multiplexed, is used. In general, for increasing transmission capacity, it is preferable that the number of wavelengths to be multiplexed is large. Therefore, for example, a plurality of optical signals having different wavelengths, such as so-called L-band (wavelength of 1565 nm to 1625 nm) optical signals and C-band (wavelength of 1530 nm to 1565 nm) optical signals, are multiplexed.

Transmission loss occurs when a wavelength-multiplexed optical signal is transmitted through an optical transmission line. Therefore, various methods are used to compensate for the transmission loss. For example, Japanese unexamined patent application publication No. 2004-333980 proposes a method of compensating for loss of an optical signal by coupling Raman excitation light output from a light source to an optical transmission line to perform Raman amplification of the optical signal.

In a general system using wavelength separating means, a reception wavelength of the optical transceiver on the reception side is determined by the setting of a transmission wavelength of each port of the wavelength separating means.

### SUMMARY

In a case where a wavelength-multiplexed optical signal is transmitted through an optical transmission line, an optical signal in the C-band acts as a Raman excitation light due to stimulated Raman scattering, and thereby an optical signal in the L-band is amplified (Inter-signal stimulated Raman scattering). Therefore, even if the signals are transmitted through the same optical transmission line, loss of the optical signal in the C-band becomes larger than loss of the optical signal in the L-band.

As a result, even if the optical signal in the C-band and the optical signal in the L-band are output at the same intensity on a transmission side, the intensity of the optical signal in the C-band is reduced compared with the intensity of the optical signal in the L-band whose loss is compensated by the inter-signal stimulated Raman scattering on a reception side. As a result, there is a problem that the intensity of the optical signal in the C-band and the intensity of the optical signal in the L-band become unbalanced, and the signal quality on the reception side deteriorates.

An aspect of the present disclosure is an optical communication system including: a first optical transmitter configured to output a first optical signal of a first wavelength at a first transmission intensity; a second optical transmitter configured to output a second optical signal of a second wavelength longer than the first wavelength at a second transmission intensity lower than the first transmission intensity; and a multiplexer configured to output a third optical signal obtained by multiplexing the first optical signal and the second optical signal to an optical transmission line, in which an intensity of the first optical signal transmitted through the optical transmission line is reduced by inter-signal stimulated Raman scattering, and the second optical signal transmitted through the optical transmission line is amplified by the inter-signal stimulated Raman scattering of the first optical signal.

An aspect of the present disclosure is an optical communication method including: outputting a first optical signal of a first wavelength at a first transmission intensity; outputting a second optical signal of a second wavelength longer than the first wavelength at a second transmission intensity lower than the first transmission intensity; and outputting a third optical signal obtained by multiplexing the first optical signal and the second optical signal to an optical transmission line; in which an intensity of the first optical signal transmitted through the optical transmission line is reduced by inter-signal stimulated Raman scattering, and the second optical signal transmitted through the optical transmission line is amplified by the inter-signal stimulated Raman scattering of the first optical signal.

According to the present disclosure, it is possible to provide an optical communication system and an optical communication method for transmitting a wavelength-multiplexed signal whose signal quality on a reception side is adjusted to desired quality.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram schematically showing a basic configuration of an optical communication system according to an example embodiment;

FIG. 2 is a block diagram schematically showing a basic configuration of an optical communication system according to an example embodiment;

FIG. 3 is a simplified diagram showing the variation in intensity in a case where a C-band optical signal and an L-band optical signal are transmitted through an optical transmission line;

FIG. 4 is a simplified diagram showing variation in intensity in a case where a transmission intensity of a L-band optical signal is set lower than a transmission intensity of a C-band optical signal by an amount of amplification due to stimulated Raman scattering between signals;

FIG. 5 is a diagram schematically showing a configuration of a modified example of an optical communication system according to an example embodiment;

FIG. 6 is a diagram schematically showing a configuration of an optical communication system according to an example embodiment;

FIG. 7 is a diagram schematically showing a configuration of an optical communication system according to an example embodiment; and

FIG. 8 is a flowchart of an intensity adjustment operation for of optical signals output from a multiplexer in an optical communication system according to an example embodiment.

### EXAMPLE EMBODIMENTS

An example embodiment according to the present disclosure will be described hereinafter with reference to the drawings. The same elements are assigned the same reference numerals (or symbols) throughout the drawings, and redundant descriptions thereof will be omitted as appropriate.

An example embodiment in the following descriptions may be applied to any of example embodiments described hereinafter or to a combination of two or more of these example embodiments, and the application thereof is not limited to any specific example embodiment.

### First Example Embodiment

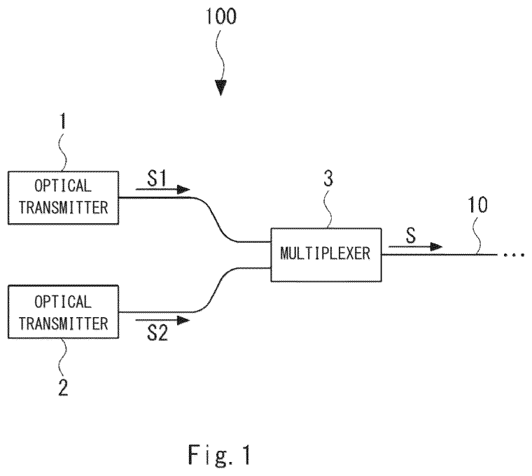

An optical communication system according to a first example embodiment will be described. FIG. 1 is a block diagram schematically showing a basic configuration of an optical communication system according to an example embodiment. An optical communication system 100 shown in FIG. 1 includes at least optical transmitters 1 and 2, and a multiplexer 3.

Each of the optical transmitters 1 and 2 outputs an optical signal obtained by modulating a light of a predetermined wavelength by a predetermined modulation method in accordance with an input data signal. The optical transmitters 1 and 2 may have an optical signal transmission function of an optical transceiver, for example. Hereinafter, the optical transmitters 1 and 2 are also referred to as first and second optical transmitters, respectively.

The optical transmitter 1 outputs an optical signal S1 of a wavelength λ1 to the multiplexer 3. The optical transmitter 2 outputs an optical signal S2 of a wavelength λ2 to the multiplexer 3. Here, the wavelength λ1 is shorter than the wavelength λ2. Here, the wavelength λ1 is a C-band wavelength. The wavelength λ2 is a L-band wavelength. Hereinafter, the wavelengths λ1 and λ2 are also referred to as first and second wavelengths, respectively. The optical signals S1 and S2 are also referred to as first and second optical signals, respectively.

The multiplexer 3 wavelength-multiplexes the optical signal S1 of the wavelength λ1 and the optical signal S2 of the wavelength λ2. The multiplexer 3 then outputs a wavelength-multiplexed optical signal S obtained by wavelength-multiplexing the optical signal S1 and the optical signal S2 to an optical transmission line 10. The optical transmission line 10 is an optical transmission line made of a medium capable of transmitting an optical signal, such as an optical fiber. Hereinafter, the wavelength-multiplexed optical signal S is also referred to as a third optical signal.

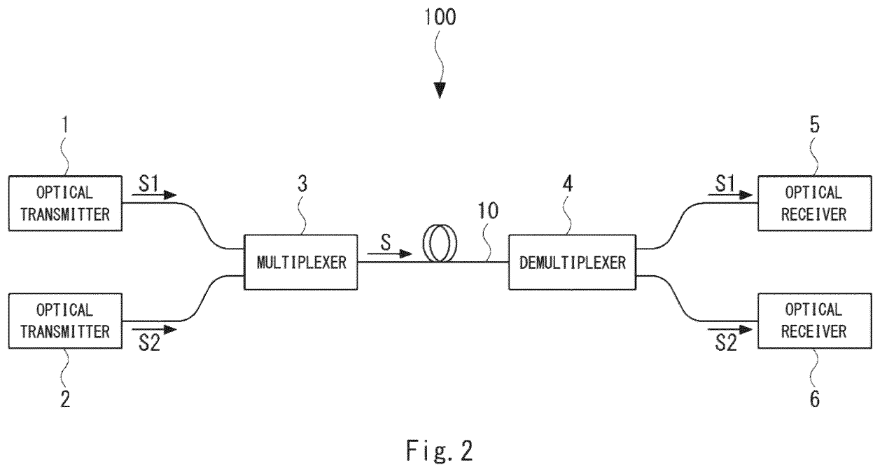

A configuration of a reception side of the optical communication system 100 according to the first example embodiment will be described. FIG. 2 is a block diagram schematically showing a basic configuration of an optical communication system according to an example embodiment. As compared with FIG. 1, the optical communication system 100 shown in FIG. 2 further includes a demultiplexer 4, and optical receivers 5 and 6.

The demultiplexer 4 demultiplexes the optical signal S1 of the wavelength λ1 and the optical signal S2 of the wavelength λ2. The demultiplexer 4 outputs the wavelength-demultiplexed optical signal S1 to the optical receiver 5. The demultiplexer 4 outputs the wavelength-demultiplexed optical signal S2 to the optical receiver 6.

The optical receivers 5 and 6 demodulate the received optical signals and output data signals, respectively. The optical receivers 5 and 6 may have an optical signal reception function of an optical transceiver, for example. Hereinafter, the optical receivers 5 and 6 are also referred to as first and second optical receivers, respectively.

The optical receiver 5 is configured as an optical receiver capable of receiving an optical signal of the wavelength λ1. Thus, the optical receiver 5 receives the optical signal S1 output from the demultiplexer 4. The optical receiver 6 is configured as an optical receiver capable of receiving an optical signal of the wavelength λ2. Thus, the optical receiver 6 receives the optical signal S2 output from the demultiplexer 4.

Next, the transmission of the optical signal in the optical communication system 100 will be described in more detail. In the present configuration, in a case where the wavelength-multiplexed optical signal S is transmitted through the optical transmission line 10, the power of the optical signal S1 of the wavelength λ1 multiplexed to the wavelength-multiplexed optical signal S transitions to a signal light of a wavelength (λᵢ−λⱼ=Ω) separated by a fixed wavelength due to the stimulated Raman scattering caused by the medium of the optical transmission line 10 and optical signals having other wavelengths. Thus, in a case where the second wavelength of the optical signal S2 multiplexed to the wavelength-multiplexed optical signal S satisfies Ω (i.e. when it is the same as or approximate to the wavelength of the Raman scattered light), the optical signal S2 is amplified by the inter-signal Raman scattering. As described above, in the optical transmission line 10, since the wavelength λ1 is in the C-band and the wavelength λ2 is in the L-band, the optical signal S2 of the L-band is amplified by using the optical signal S1 of the C-band as a pump light, and amplification due to the inter-signal stimulated Raman scattering is performed.

Therefore, for the optical signal S2 when it reaches the reception side, the amount of decrease in reception intensity is suppressed by intensity compensation due to the inter-signal stimulated Raman scattering in the optical transmission line 10. On the other hand, for the optical signal S1 when it reaches the reception side, the amount of decrease in reception intensity is larger than that of the optical signal S2 by the amount of power transition to the optical signal S2 due to the inter-signal stimulated Raman scattering. Therefore, an imbalance occurs between a reception intensity of the optical signal S1 and a reception intensity of the optical signal S2.

For example, if a transmission intensity of the optical signal S1 output from the optical transmitter 1 and a transmission intensity of the optical signal S2 output from the optical transmitter 2 are the same and a difference in transmission loss is ignored for the sake of simplification, the reception intensity of the optical signal S1 is lower than the reception intensity of the optical signal S2 by the amount of amplification of the optical signal S2 due to the inter-signal stimulated Raman scattering.

Hereinafter, the transmission intensities of the optical signals S1 and S2 are also referred to as first and second transmission intensities, respectively. The reception intensities of the optical signals S1 and S2 are also referred to as first and second reception intensities, respectively.

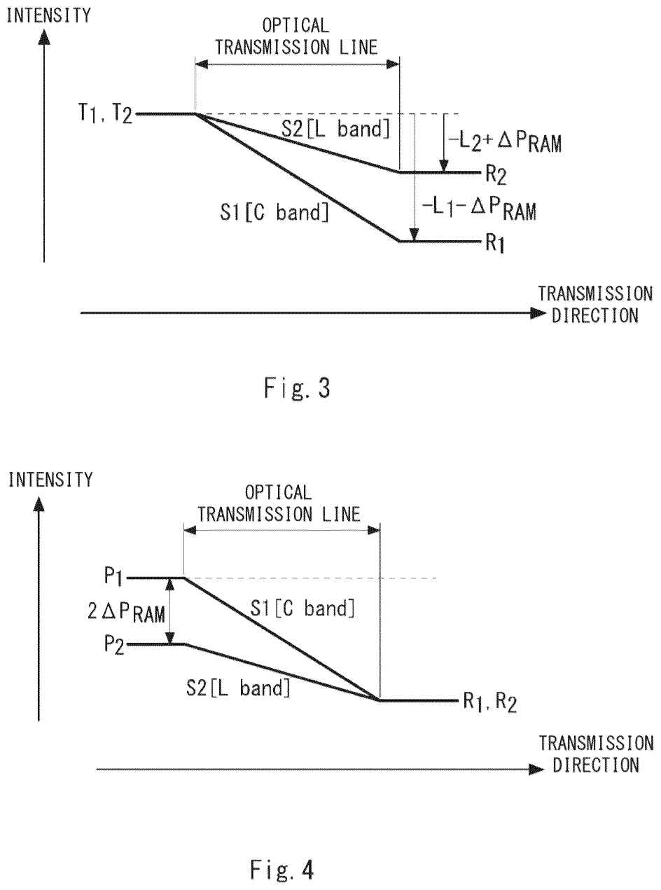

FIG. 3 is a simplified diagram showing variations in intensity in a case where the C-band optical signal S1 and the L-band optical signal S2 are transmitted through the optical transmission line. As described above, the L-band optical signal S2 is amplified by the inter-signal stimulated Raman scattering using the C-band optical signal S1. Therefore, as shown in FIG. 3, even if the transmission intensity T₁ of the optical signal S1 and the transmission intensity T₂ of the optical signal S2 are the same, the reception intensity R₁ of the optical signal S1 becomes lower than the reception intensity R₂ of the optical signal S2.

Therefore, in the optical communication system 100, the transmission intensity T₁ of the optical signal S1 and the transmission intensity T₂ of the optical signal S2 are adjusted so that the reception intensity R₁ of the optical signal S1 and the reception intensity R₂ of the optical signal S2 are equal or a difference therebetween is suppressed to a negligible degree. Thus, an imbalance between the reception intensity R₁ of the optical signal S1 and the reception intensity R₂ of the optical signal S2 caused by the amplification of the optical signal S2 by the inter-signal stimulated Raman scattering in the optical transmission line 10 is corrected.

Next, the significance of adjusting the transmission intensity T₁ of the optical signal S1 and the transmission intensity T₂ of the optical signal S2 in the optical communication system 100 will be described using a simplified comparative example of the relationship between the transmission intensity T₁ of the optical signal S1 and the transmission intensity T₂ of the optical signal S2.

Transmission loss in a case where the optical signal S1 is transmitted alone through the optical transmission line 10 is referred to as L₁. In this case, the reception intensity R₁ of the optical signal S1 received by the optical receiver 5 is expressed by the following expression.

$${R}_{1} = {T}_{1} - {L}_{1} - Δ {P}_{RAM} \qquad [ 1 ]$$

Transmission loss in a case where the optical signal S2 is transmitted alone through the optical transmission line 10 is expressed by L₂. An amplification amount of the optical signal S2 due to the inter-signal stimulated Raman scattering in the optical transmission line 10 is expressed by ΔP_{RAM}. In this case, the reception intensity R₂ of the optical signal S2 received by the optical receiver 6 is expressed by the following expression.

$${R}_{2} = {T}_{2} - {L}_{2} + Δ {P}_{RAM} \qquad [ 2 ]$$

From Expressions [1] and [2], the following relationship can be derived:

$$\begin{matrix}{T}_{1} - {T}_{2} = R 1 - R 2 + {L}_{1} - {L}_{2} + 2 Δ {P}_{RAM} \\ = Δ R + Δ L + 2 Δ {P}_{RAM}\end{matrix} \qquad [ 3 ]$$

ΔL in Equation [3] is a transmission loss difference L₁−L₂ between the optical signals S1 and S2. ΔR is a reception intensity difference R₁−R₂ between the optical signals S1 and S2.

Therefore, the transmission intensity T₂ of the optical signal S2 is expressed by the following expression.

$${T}_{2} = {T}_{1} - Δ R - Δ L - 2 Δ {P}_{RAM} \qquad [ 4 ]$$

Here, it is assumed that the transmission intensity T₁ of the optical signal S1 and the transmission intensity T₂ of the optical signal S2 are adjusted by a general method to compensate for the transmission loss difference ΔL. The transmission intensity of the optical signal S1 after the transmission loss compensation is defined as P₁. The transmission intensity of the optical signal S2 after the transmission loss compensation is defined as P₂. In this case, ΔL=0 and Expression [4] is rewritten into Expression [5].

$$[ Equation 5 ]$$

$${P}_{2} = {P}_{1} - Δ R - 2 Δ {P}_{RAM} \qquad [ 5 ]$$

That is, to equalize the reception intensity R₁ of the optical signal S1 and the reception intensity R₂ of the optical signal S2 (ΔR=0) in a state where the transmission loss is compensated, it is understood that the transmission intensity of the optical signal S2 may be set lower than the transmission intensity of the optical signal S1 by an amount corresponding to the amplification amount 2ΔP_{RAM} of the optical signal S2 by inter-signal Raman amplification (from Expression [5], ΔR=P₁−P₂−2ΔP_{RAM}=0->P₁−P₂=2ΔP_{RAM}). Alternatively, it is understood that the transmission intensity of S1 may be set higher than the transmission intensity of the optical signal S2 by the amount 2ΔP_{RAM} of the transition from the optical signal S1 to the optical signal S2 by the inter-signal stimulated Raman scattering.

Therefore, in the present configuration, the transmission intensity T₁ of the optical signal S1 and the transmission intensity T₂ of the optical signal S2 are adjusted so that the transmission intensity T₂ of the optical signal S2 is lower than the transmission intensity T₁ of the optical signal S1. Alternatively, the transmission intensity T₁ of the optical signal S1 and the transmission intensity T₂ of the optical signal S2 are adjusted so that the transmission intensity T₁ of the optical signal S1 is higher than the transmission intensity T₂ of the optical signal S2. Thus, the difference between the reception intensity R₁ of the optical signal S1 and the reception intensity R₂ of the optical signal S2 can fall within an allowable range. Hereinafter, the allowable range of the difference between the reception intensity R₁ of the optical signal S1 and the reception intensity R₂ of the optical signal S2 is also referred to as a first predetermined range. More desirably, the reception intensity R₁ of the optical signal S1 and the reception intensity R₂ of the optical signal S2 may be equal. Thus, the imbalance between the reception intensity R₁ of the optical signal S1 and the reception intensity R₂ of the optical signal S2 can be suitably corrected.

As a result, the reception intensities of all optical signals can be flattened by compensating for the difference in the reception intensities between the C-band optical signal and the L-band optical signal. As a result, it is possible to improve OSNR degradation on a high-frequency side, that is, on a short-wave side, where the intensity degradation due to the inter-signal stimulated Raman scattering is large in multiband transmission, and resulting Q factor degradation.

FIG. 4 is a simplified diagram showing a variation in the intensity in a case where the transmission intensity of the L-band optical signal is set lower than the transmission intensity of the C-band optical signal by the amount of amplification due to the inter-signal stimulated Raman scattering. In FIG. 4, for simplicity, it is assumed that the transmission loss L₁ of the optical signal S1 and the transmission loss L₂ of the optical signal S2 are the same. This assumption is merely for simplifying the diagram, and it does not deny that the transmission loss of the light having different wavelengths may be different.

According to the optical communication system 100, as shown in FIG. 4, by making the transmission intensity T₂ of the L-band optical signal S2 lower than the transmission intensity T₁ of the C-band optical signal S1 by the power transition of the stimulated Raman scattering, or by making the transmission intensity T₁ of the C-band optical signal S1 higher than the transmission intensity T₂ of the L-band optical signal S2, the imbalance between the reception intensity R₁ of the optical signal S1 and the reception intensity R₂ of the optical signal S2 can be corrected.

It is known that when the transmission intensity of an optical signal is increased and the total power in a fiber becomes too high, nonlinear effects such as self-phase modulation (SPM) become large in the optical signal on a reception side. Therefore, if the transmission intensity T₁ of the optical signal S1 is made too large to correct the imbalance between the reception intensity R₁ of the optical signal S1 and the reception intensity R₂ of the optical signal S2, generalized signal-to-noise ratio (GSNR: Generalized Signal to Noise Ratio) and optical signal-to-noise ratio (OSNR: Optical Signal to Noise Ratio) of the optical signal S1 tend to deteriorate.

Therefore, it is desirable that the transmission intensity T₁ of the optical signal S1 be kept as low as possible. On the other hand, in the optical communication system 100, instead of increasing the transmission intensity T₁ of the optical signal S1, the transmission intensity T₂ of the optical signal S2 may be made lower than the transmission intensity T₁ of the optical signal S1 by the amount compensated by the Raman amplification. Thus, since the transmission intensity T₁ of the optical signal S1 can be maintained low, it is also possible to prevent the GSNR and OSNR of the optical signal S1 from deteriorating during reception.

Furthermore, in a case where an optical signal is transmitted through an optical transmission line, it is known that a so-called tilt phenomenon, in which the reception intensity of the optical signal varies according to a wavelength, occurs as described in Japanese unexamined patent application publication No. 2019-186735, for example. The tilt phenomenon appears as a wavelength characteristic in which the reception intensity in a band becomes lower on a higher frequency side, that is, on a shorter wavelength side, due to occurrence of the stimulated Raman scattering in one band. Therefore, in the optical communication system 100, either or both of the transmission intensities T₁ and T₂ may be adjusted as appropriate according to the wavelengths of the optical signals S1 and S2 to compensate for the tilt phenomenon.

In the present configuration, the transmission intensity T₁ of the optical signal S1 and the transmission intensity T₂ of the optical signal S2 may be set in advance by the user of the optical communication system 100, for example.

Further, the transmission intensity T₁ of the optical signal S1 and the transmission intensity T₂ of the optical signal S2 may be set by providing a control unit in the optical communication system 100 and giving a command from the control unit to the optical transmitters 1 and 2.

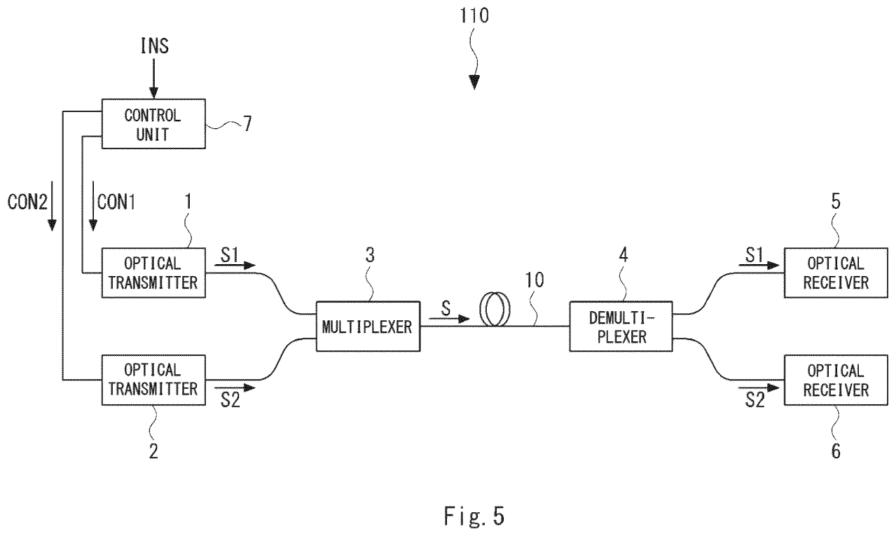

FIG. 5 is a diagram schematically showing a configuration of a modified example of an optical communication system according to an example embodiment.

An optical communication system 110 in FIG. 5 has a configuration in which a control unit 7 is further provided in the optical communication system 100. The control unit 7 outputs control signals CON1 and CON2 to the optical transmitters 1 and 2, respectively, in accordance with a command INS provided from the user of the optical communication system 110, for example. The optical transmitters 1 and 2 may set the transmission intensity T₁ of the optical signal S1 and the transmission intensity T₂ of the optical signal S2, respectively, in accordance with the control signals CON1 and CON2.

### Second Example Embodiment

In the present example embodiment, an optical communication system for Raman amplifying the wavelength-multiplexed optical signal S by coupling a pump light for Raman amplification to the optical transmission line 10 will be described.

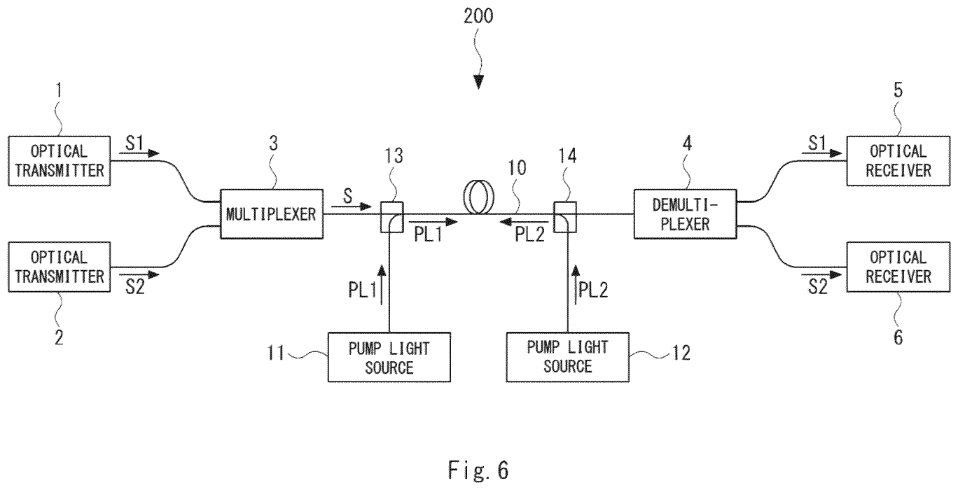

FIG. 6 is a diagram schematically showing a configuration of an optical communication system according to an example embodiment. An optical communication system 200 of FIG. 6 has a configuration in which pump light sources 11 and 12, and optical couplers 13 and 14 are further provided to the optical communication system 100.

The pump light source 11 outputs a pump light PL1 to the optical transmission line 10. In the present example, the optical transmission line 10 is provided with an optical coupler 13. The optical coupler 13 is configured as an optical coupler, for example. The pump light source 11 outputs the pump light PL1 to the optical coupler 13. The optical coupler 13 couples the pump light PL1 to the optical transmission line 10 so that the pump light PL1 propagates in a transmission direction of the wavelength-multiplexed optical signal S. Thus, the wavelength-multiplexed optical signal S is amplified by forward Raman amplification using the pump light PL1. Hereinafter, the pump light source 11 is also referred to as a first pump light source. The pump light PL1 is also referred to as a first pump light. The optical coupler 13 is also referred to as a first optical coupler.

The pump light sources 11 and 12 may be configured as any laser light source such as a laser module that outputs a pump light.

The pump light source 12 outputs a pump light PL2 to the optical transmission line 10. In the present example, the optical transmission line 10 is provided with an optical coupler 14. The optical coupler 14 is configured as an optical coupler, for example. The pump light source 12 outputs the pump light PL2 to the optical coupler 14. The optical coupler 14 couples the pump light PL2 to the optical transmission line 10 so that the pump light PL2 propagates in a direction opposite to the transmission direction of the wavelength-multiplexed optical signal S. Thus, the wavelength-multiplexed optical signal S is amplified by backward Raman amplification using the pump light PL2. Hereinafter, the pump light source 12 is also referred to as a second pump light source. The pump light PL2 is also referred to as a second pump light. The optical coupler 14 is also referred to as a second optical coupler.

In the optical communication system 200, by coupling the pump lights PL1 and PL2 to the optical transmission line, the wavelength-multiplexed optical signal can be Raman amplified. Therefore, it is possible to reduce the transmission intensity T₁ of the optical signal S1 and the transmission intensity T₂ of the optical signal S2, which are necessary for setting the reception intensity R₁ of the optical signal S1 and the reception intensity R₂ of the optical signal S2 to desired values. Thus, it is possible to further suppress nonlinear effects such as SPM that occur in response to an increase in the transmission intensity of the optical signal.

In the optical communication system 200, a wavelength 23 of the pump lights PL1 and PL2 may be set so that the gain of Raman amplification of the C-band optical signal S1 is greater than the gain of Raman amplification of the L-band optical signal S2. Hereinafter, the wavelength 23 is also referred to as a third wavelength. The wavelength of the pump light PL1 and the wavelength of the pump light PL2 may be the same or different.

Thus, the wavelength-multiplexed signal S can be Raman amplified by the pump lights PL1 and PL2 so that there is no imbalance in the reception intensities between the optical signal S1 and the optical signal S2.

### Third Example Embodiment

In an optical communication system, it is required that an optical signal received by an optical receiver be kept at a constant quality. Therefore, for example, the GSNR of the optical signal received by the optical receiver is used as the index of signal quality. For example, Emanuele Virgillito et al., “Single-vs. Multi-Band Optimized Power Control in C+L WDM 400 G Line Systems,” 2021, Optical Fiber Communications Conference and Exhibition (OFC), describes a calculation simulation of the GSNR. Here, a process of converting the OSNR received by the optical receiver into the GSNR is performed.

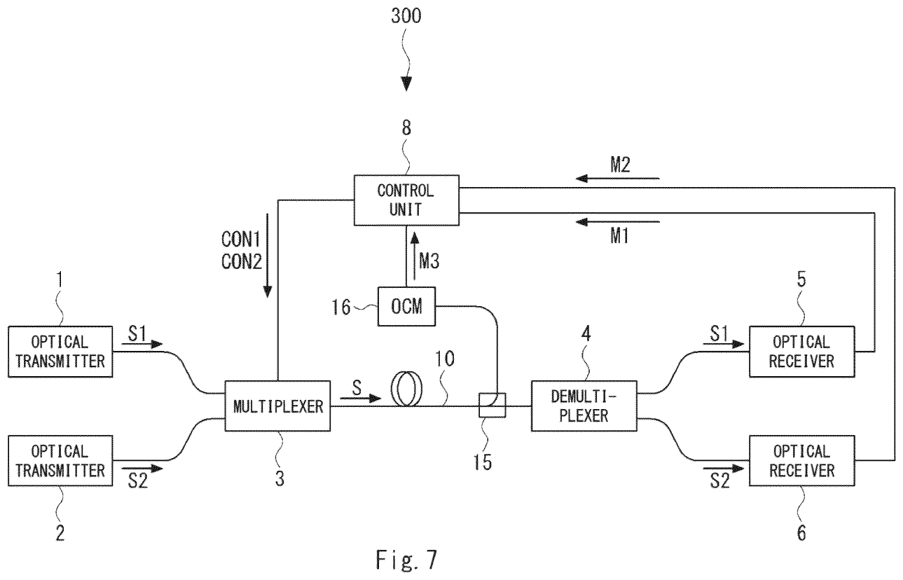

On the other hand, in the present configuration, an optical communication system for monitoring the quality of the optical signal received by the optical receiver by the OSNR will be described. FIG. 7 is a diagram schematically showing a configuration of an optical communication system according to an example embodiment. An optical communication system 300 shown in FIG. 7 has a configuration in which a control unit 8 is further provided to the optical communication system 100. The control unit 8 may be configured to manage the optical communication system 300 such as a network management system (NMS).

In the optical communication system 300, the optical receiver 5 measures the OSNR of the optical signal S1. The optical receiver 5 outputs a measurement signal M1 indicating the measured OSNR of the optical signal S1 to the control unit 8. The optical receiver 6 measures the OSNR of the optical signal S2. The optical receiver 6 outputs a measurement signal M2 indicating the OSNR of the measured optical signal S2 to the control unit 8.

The optical communication system 300 may also include an optical coupler 15 and an optical channel monitor (OCM) 16 as shown in FIG. 7. The optical coupler 15 is inserted at a position on the reception side of the optical transmission line 10, for example, in front of the demultiplexer 4. The optical coupler 15 branches a part of the wavelength-multiplexed optical signal S transmitted through the optical transmission line 10 and outputs the branched optical signal to the OCM16. The OCM16 measures the intensity of the wavelength-multiplexed optical signal S transmitted through the optical transmission line 10 based on the part of the wavelength-multiplexed optical signal S that has been input from the optical coupler 15. The OCM16 then outputs a measurement signal M3 indicating a measurement result to the control unit 8. The optical coupler 15 is merely an example, and any optical branching means capable of similarly branching the wavelength-multiplexed optical signal S may be used. The OCM16 is merely an example, and any measuring means for measuring the intensity of the wavelength-multiplexed optical signal S may be used.

The control unit 8 calculates an average value of the optical signal based on the measurement signals M1 and M2 or the measurement signal M3. The control unit 8 determines whether or not the OSNR of the optical signal S1 is within an allowable range based on the average value or a value instructed in advance from an external system as a target value. The control unit 8 determines whether or not the OSNR of the optical signal S2 is within an allowable range based on the measurement signal M2. Hereinafter, the allowable range of the OSNR of the optical signal S1 is also referred to as a second predetermined range. The allowable range of the OSNR of the optical signal S2 is also referred to as a second predetermined range.

The control unit 8 outputs the control signals CON1 and CON2 to the multiplexer 3 according to determination results. The multiplexer 3 adjusts the transmission intensity of the optical signal S1 and the transmission intensity of the optical signal S2 output from the multiplexer 3 according to the control signals CON1 and CON2. The multiplexer 3 is assumed to be a WSS or the like, but if it has the same function, the device type is not limited.

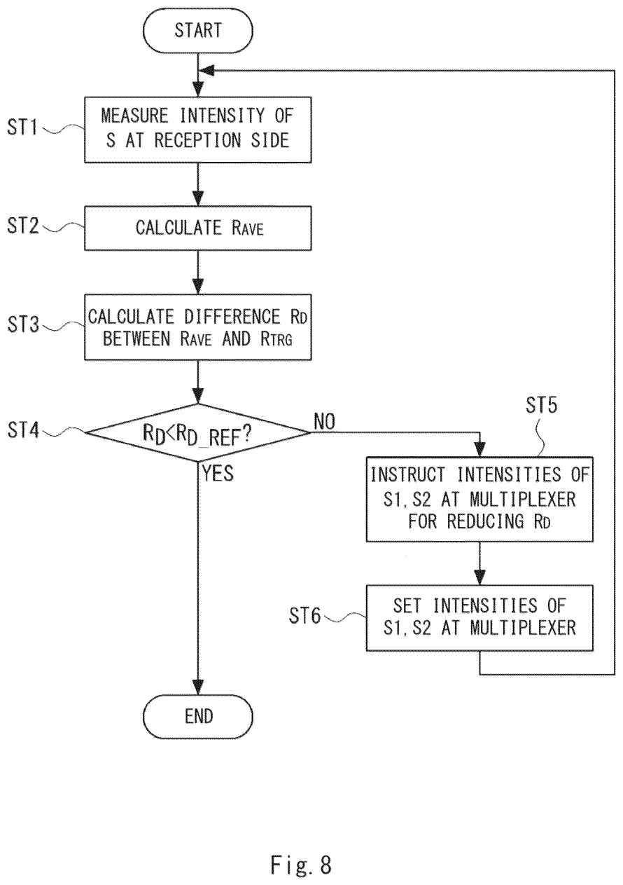

Next, an intensity adjustment operation of the optical signals S1 and S2 output from the multiplexer 3 in the optical communication system 300 will be described. FIG. 8 is a flowchart of an intensity adjustment operation of optical signals output from a multiplexer in an optical communication system according to an example embodiment.

### Step ST1

In a state where the wavelength-multiplexed optical signal S is transmitted, the intensity of the wavelength-multiplexed optical signal S on the reception side is measured. First, a first measuring method will be described. The optical receiver 3 measures the reception intensity R₁ of the optical signal S1. The optical receiver 3 includes information indicating the measured reception intensity R₁ in the measurement signal M1 and then outputs the measurement signal M1. The optical receiver 4 measures the reception intensity R₂ of the optical signal S2. The optical receiver 4 includes information indicating the measured reception intensity R₂ in the measurement signal M2 and then outputs the measurement signal M2.

Next, a second measuring method will be described. The OCM16 measures the intensity of the optical wavelength-multiplexed optical signal S on the reception side based on the wavelength-multiplexed optical signal S branched by the optical coupler 15. Then, the OCM16 outputs the measurement signal M3 indicating the measurement result to the control unit 8. The measurement signal M3 may include a signal indicating the intensities of the optical signals S1 and S2 on the reception side. The measurement signal M3 may be a signal that can be analyzed by the control unit 8 to obtain the intensities of the optical signals S1 and S2 on the reception side.

### Step ST2

The control unit 8 calculates the average value R_{AVE} of the reception intensity R₁ and the reception intensity R₂ based on the measurement signals M1 and M2 or the measurement signal M3.

### Step ST3

The control unit 8 calculates a difference R_{D} between the calculated average value R_{AVE} and a target value R_{TRG}.

### Step ST4

The control unit 8 determines whether or not the difference R_{D} is smaller than a reference value R_{D_REF}. In a case where the difference R_{D} is smaller than the reference value R_{D_REF}, the process ends.

### Step ST5

In a case where the difference R_{D} is larger than the reference value R_{D_REF}, the control unit 8 instructs the output intensities of the optical signals S1 and S2 after adjustment by the control signals CON1 and CON2 to adjust the output intensities of the optical signals S1 and S2 in the multiplexer 3 so that the difference R_{D} becomes smaller.

### Step ST6

The multiplexer 3 sets the instructed output intensity of the optical signal S1 and the instructed output intensity of the optical signal S2. Thereafter, the process returns to Step ST1.

As described above, the adjustment operation of the multiplexer 3 allows the difference R_{D} to converge to a range smaller than the reference value R_{D_REF}. Thus, the reception intensity R₁ of the optical signal S1 and the reception intensity R₂ of the optical signal S2 can be set to appropriate values. As a result, each of the OSNRs of the optical signals S1 and S2 can be maintained at an enough value.

Therefore, according to the optical communication system 300, the reception intensity R₁ of the optical signal S1 and the reception intensity R₂ of the optical signal S2 can be set to appropriate values while monitoring whether the OSNR thereof falls within predetermined ranges.

### Other Example Embodiments

Although the present disclosure is described above with reference to example embodiments, the present disclosure is not limited to the above-described example embodiments. For example, the optical transmission apparatus to which the optical transceiver according to the above-described example embodiments is attached may be various apparatuses used in an optical communication system. For example, in optical communication between terminal stations, the optical transmission apparatus may be an apparatus installed in the terminal station.

In the above-described example embodiments, the wavelength λ1 is a wavelength of the C-band and the wavelength λ2 is a wavelength of the L-band, but this is only an example. As long as the wavelength λ1 is shorter than the wavelength λ2, the wavelengths λ1 and λ2 may be arbitrary.

In the example embodiments, the configuration of performing forward Raman amplification and backward Raman amplification on the wavelength-multiplexed optical signal S has been described, but this is only an example. Both the forward Raman amplification and backward Raman amplification may be performed on the wavelength-multiplexed optical signal S, or only one of them may be performed.

In the optical communication system according to the third example embodiment, as in the optical communication system according to the second example embodiment, by providing the pump light sources 11 and 12, and the optical couplers 13 and 14, the forward Raman amplification and/or backward Raman amplification may be performed on the wavelength-multiplexed optical signal S.

Each of the drawings is merely an example for explaining one or more example embodiments. Each of the drawings is not associated with only one particular example embodiment, but may be associated with one or more other example embodiments. As will be appreciated by those skilled in the art, various features or steps described with reference to any one of the drawings may be combined with features or steps shown in one or more other figures to, for example, create an example embodiment that is not explicitly shown or described in the present disclosure. Not all of the features or steps shown in any one of the drawings are required to explain an example embodiment, and some of the features or steps may be omitted. The order of the steps described in any one of the drawings may be changed as appropriate.

The first to third example embodiments can be combined as desirable by one of ordinary skill in the art.

While the disclosure has been particularly shown and described with reference to embodiments thereof, the disclosure is not limited to these embodiments. It will be understood by those of ordinary skill in the art that various changes in form and details may be made therein without departing from the spirit and scope of the present disclosure as defined by the claims.

The whole or part of the example embodiments disclosed above can be described as, but not limited to, the following supplementary notes.

### (Supplementary Note 1)

An optical communication system comprising: a first optical transmission means for outputting a first optical signal of a first wavelength at a first transmission intensity; a second optical transmission means for outputting a second optical signal of a second wavelength longer than the first wavelength at a second transmission intensity lower than the first transmission intensity; and a multiplexing means for outputting a third optical signal obtained by multiplexing the first optical signal and the second optical signal to an optical transmission line, in which an intensity of the first optical signal transmitted through the optical transmission line is reduced by inter-signal stimulated Raman scattering, and the second optical signal transmitted through the optical transmission line is amplified by the inter-signal stimulated Raman scattering of the first optical signal.

### (Supplementary Note 2)

The optical communication system according to Supplementary note 1, in which the second transmission intensity is determined according to an intensity compensation amount in amplification of the first optical signal due to the inter-signal stimulated Raman scattering.

### (Supplementary Note 3)

The optical communication system according to Supplementary note 1 or 2, further including: a demultiplexing means for demultiplexing the third optical signal transmitted through the optical transmission line into the first optical signal and the second optical signal; a first optical reception means for receiving the first optical signal that has been wavelength-demultiplexed by the demultiplexing means; and a second optical reception means for receiving the second optical signal that has been wavelength-demultiplexed by the demultiplexing means; in which the first and second transmission intensities are determined so that a difference between a first reception intensity of the first optical signal received by the first optical reception means and a second reception intensity of the second optical signal received by the second optical reception means falls within a first predetermined range.

### (Supplementary Note 4)

The optical communication system according to Supplementary note 3, in which the first and second transmission intensities are determined so that a tilt phenomenon in which the first reception intensity varies according to a wavelength of the first optical signal and a tilt phenomenon in which the second reception intensity varies according to a wavelength of the second optical signal are compensated.

### (Supplementary Note 5)

The optical communication system according to Supplementary note 1 or 2, further including: a first pump light source configured to output a first pump light; and a first optical coupling means for coupling the first pump light to the optical transmission line so that the first pump light is transmitted through the transmission line in a transmission direction of the third optical signal, in which the third optical signal is amplified by forward Raman amplification using the first pump light.

### (Supplementary Note 6)

The optical communication system according to Supplementary note 5, in which a wavelength of the first pump light is set to a wavelength at which a gain of forward Raman amplification of the first optical signal using the first pump light is greater than a gain of forward Raman amplification of the second optical signal using the first pump light.

### (Supplementary Note 7)

The optical communication system according to Supplementary note 1 or 2, further including: a second pump light source configured to output a second pump light; and a second optical coupling means for coupling the second pump light to the optical transmission line so that the second pump light is transmitted through the optical transmission line in a direction opposite to the transmission direction of the third optical signal, in which the third optical signal is amplified by backward Raman amplification using the second pump light.

### (Supplementary Note 8)

The optical communication system according to Supplementary note 7, in which a wavelength of the second pump light is set to a wavelength at which a gain of backward Raman amplification of the first optical signal using the second pump light is greater than a gain of backward Raman amplification of the second optical signal using the second pump light.

### (Supplementary Note 9)

The optical communication system according to Supplementary note 3, further including a control means for controlling output intensities of the first and second optical signals in the multiplexing means so that a difference between an average value of the first reception intensity and the second reception intensity, and a predetermined target value becomes smaller than a predetermined reference value.

### (Supplementary Note 10)

The optical communication system according to Supplementary note 1 or 2, further comprising a control means for setting the first transmission intensity to the first optical transmission means and setting the second transmission intensity to the second optical transmission means in response to a provided command.

### (Supplementary Note 11)

An optical communication method including: outputting a first optical signal of a first wavelength at a first transmission intensity; outputting a second optical signal of a second wavelength longer than the first wavelength at a second transmission intensity lower than the first transmission intensity; and outputting a third optical signal obtained by multiplexing the first optical signal and the second optical signal to an optical transmission line; in which an intensity of the first optical signal transmitted through the optical transmission line is reduced by inter-signal stimulated Raman scattering, and the second optical signal transmitted through the optical transmission line is amplified by the inter-signal stimulated Raman scattering of the first optical signal.

The first to third example embodiments can be combined as desirable by one of ordinary skill in the art.

While the disclosure has been particularly shown and described with reference to embodiments thereof, the disclosure is not limited to these embodiments. It will be understood by those of ordinary skill in the art that various changes in form and details may be made therein without departing from the spirit and scope of the present disclosure as defined by the claims.

What is claimed is:

1. An optical communication system comprising:
a first optical transmitter configured to output a first optical signal of a first wavelength at a first transmission intensity;
a second optical transmitter configured to output a second optical signal of a second wavelength longer than the first wavelength at a second transmission intensity lower than the first transmission intensity; and
a multiplexer configured to output a third optical signal obtained by multiplexing the first optical signal and the second optical signal to an optical transmission line,
wherein an intensity of the first optical signal transmitted through the optical transmission line is reduced by inter-signal stimulated Raman scattering, and
the second optical signal transmitted through the optical transmission line is amplified by the inter-signal stimulated Raman scattering of the first optical signal.

2. The optical communication system according to claim 1, wherein the second transmission intensity is determined according to an intensity compensation amount in amplification of the first optical signal due to the inter-signal stimulated Raman scattering.

3. The optical communication system according to claim 1, further comprising:
a demultiplexer configured to demultiplex the third optical signal transmitted through the optical transmission line into the first optical signal and the second optical signal;
a first optical receiver configured to receive the first optical signal that has been wavelength-demultiplexed by the demultiplexer; and
a second optical receiver configured to receive the second optical signal that has been wavelength-demultiplexed by the demultiplexer; wherein
the first and second transmission intensities are determined so that a difference between a first reception intensity of the first optical signal received by the first optical receiver and a second reception intensity of the second optical signal received by the second optical receiver falls within a first predetermined range.

4. The optical communication system according to claim 3, wherein the first and second transmission intensities are determined so that a tilt phenomenon in which the first reception intensity varies according to a wavelength of the first optical signal and a tilt phenomenon in which the second reception intensity varies according to a wavelength of the second optical signal are compensated.

5. The optical communication system according to claim 1, further comprising:
a first pump light source configured to output a first pump light; and
a first optical coupler configured to couple the first pump light to the optical transmission line so that the first pump light is transmitted through the transmission line in a transmission direction of the third optical signal, wherein
the third optical signal is amplified by forward Raman amplification using the first pump light.

6. The optical communication system according to claim 5, wherein a wavelength of the first pump light is set to a wavelength at which a gain of forward Raman amplification of the first optical signal using the first pump light is greater than a gain of forward Raman amplification of the second optical signal using the first pump light.

7. The optical communication system according to claim 1, further comprising:
a second pump light source configured to output a second pump light; and
a second optical coupler configured to couple the second pump light to the optical transmission line so that the second pump light is transmitted through the optical transmission line in a direction opposite to the transmission direction of the third optical signal, wherein
the third optical signal is amplified by backward Raman amplification using the second pump light.

8. The optical communication system according to claim 7, wherein a wavelength of the second pump light is set to a wavelength at which a gain of backward Raman amplification of the first optical signal using the second pump light is greater than a gain of backward Raman amplification of the second optical signal using the second pump light.

9. The optical communication system according to claim 3, further comprising a control unit configured to control output intensities of the first and second optical signals in the multiplexer so that a difference between an average value of the first reception intensity and the second reception intensity, and a predetermined target value becomes smaller than a predetermined reference value.

10. The optical communication system according to claim 1, further comprising a control unit configured to set the first transmission intensity to the first optical transmitter and set the second transmission intensity to the second optical transmitter in response to a provided command.

11. An optical communication method comprising:
outputting a first optical signal of a first wavelength at a first transmission intensity;
outputting a second optical signal of a second wavelength longer than the first wavelength at a second transmission intensity lower than the first transmission intensity; and
outputting a third optical signal obtained by multiplexing the first optical signal and the second optical signal to an optical transmission line; wherein
an intensity of the first optical signal transmitted through the optical transmission line is reduced by inter-signal stimulated Raman scattering, and
the second optical signal transmitted through the optical transmission line is amplified by the inter-signal stimulated Raman scattering of the first optical signal.
